(19) United States
(12) Patent Application Publication
(10) Pub. No.: US 2013/0098174 A1
(43) Pub. Date: Apr. 25, 2013

(54) METHOD FOR MEASURING PARTICLES ADHERING TO A BODY

(71) Applicants: Roger Heller, Weisslingen (CH); Stefan Buob, Winterthur (CH)

(72) Inventors: Roger Heller, Weisslingen (CH); Stefan Buob, Winterthur (CH)

(21) Appl. No.: 13/806,011

(22) PCT Filed: Jul. 8, 2011
(86) PCT No.: PCT/EP2011/061600

§ 371 Date: Dec. 20, 2012

(30) Foreign Application Priority Data
Jul. 13, 2010 (EP) 10169388.5

(51) Int. Cl. G01N 21/01

(52) U.S. Cl. CPC G01N 21/01
USPC 73/864.91

(57) ABSTRACT

The aim of the present disclosure is to reliably measure particles (3) adhering to a body (1). To this end, particles are transferred from the body (1) to a test body (2) and measured thereon. In this way, for example, the performance of dust collectors for, for example, pharmaceutical tablets can be reliably determined with a high level of repeat accuracy.

The invention relates to a method for measuring particles adhering to a body.

In the present context, the term “measuring” is meant to include e.g. counting the number of particles on a defined surface area, measuring the size of the particles, and/or detecting the distribution of the particles on the surface.

Methods and apparatus for inspecting bodies such as tablets or capsules are known where e.g. the firmness of the bodies is measured or their surface is tested for cracks or adhering contaminations. To this end, among others, image processing methods are applied. However, if the quality of bodies is to be tested with regard to particles of the same material as the bodies that are loosely adhering to the surface of the bodies, conventional testing methods quickly reach their limits because the particles and the bodies have the same color and the particles are therefore hardly recognizable due to the low contrast. Also, due to the identical material composition, the particles have a nearly identical density as the bodies, thereby also making the inspection more difficult.

It is the object of the invention to provide a method that allows a reliable measurement of particles adhering to a body. Moreover, the method should be at least largely automatable.

This object is achieved in that particles are transferred from the body to a test body and are measured on the latter.

In particular, this solution offers the advantage that the measurement is not carried out on the body itself but on the test body. This allows choosing the properties of the test body in a nearly arbitrary manner and thus adapting them to the bodies to be measured and to the chosen measuring method.

According to one embodiment the test body has a color that differs from the color of the body, preferably a contrasting color. In this manner the particles are well distinguishable on the test body.

According to a further embodiment the test body consists of a plastically or elastically deformable material. This allows the test body to adapt to the surface of the body, particularly also when this surface is curved.

According to another embodiment the test body consists of synthetic material, rubber, or natural rubber. In tests, good results have been achieved with these materials.

According to a further embodiment the test body has the shape of a membrane. A membrane can e.g. be stretched over a hollow support body, whereby a high repeat accuracy in the transfer of the particles is achieved.

According to a further embodiment the transfer of the particles to the test body is achieved by an electrostatic potential difference. The latter can be produced by a voltage source or e.g. also by rubbing the test body.

According to another embodiment the transfer of the particles to the test body is achieved by a contact between the body and the test body. The transfer can thus be achieved in a very simple manner by sort of dabbing the body with the test body, or inversely the test body with the body.

In order to improve the adhesion of the particles to the test body after the transfer, according to a further embodiment, the surface of the latter may be coated with a pressure sensitive adhesive.

According to one embodiment of the method, the measurement of the particles is achieved by analyzing a sector of the test body with the particles transferred thereto. If the sector is chosen larger than the body, the geometry of the body can also be measured based on the distribution of the particles.

According to a further embodiment a digital image of the sector is recorded and electronically analyzed. In this manner, on one hand, the subjectivity inherent in any analysis by a person is eliminated, and on the other hand, the method can be automated.

According to another embodiment the analysis comprises determining the ratio of the sum of the projected areas of the particles relative to the total surface area of the sector. This allows e.g. comparisons between different samples in an extremely simple manner.

According to another embodiment the analysis includes determining the particle size distribution. The size distribution may e.g. be interesting when the quality of pressed bodies is to be assessed or the performance of a deduster is to be optimized.

According to a further embodiment the analysis includes determining the particle distribution on the sector of the test body, and therefrom shape imperfections or damages of the body are deduced. Particularly in an automated method it may be interesting to detect defective bodies simultaneously to the particle measurement.

According to another embodiment the transfer of the particles on one and the same body is repeated with respective new test bodies until no particles are detected on the test body any more, and the number of transfers where particles are detected on the test body is used as a measurement of the dust exposure of the body. In this manner, the amount of dust adhering to a body can be determined and expressed in numbers in a very simple way.

Ultimately, according to one embodiment, the body is a pressed body, in particular a pharmaceutical tablet or a capsule.

Another aspect of the invention relates to a device with a test body for implementing the method of the invention. The object of the device is to carry out the transfer of particles to test bodies in a simple manner and with a high repeat accuracy.

This object is achieved in that the test body is in the form of an elastic membrane that is stretched over a hollow support body. In particular, this arrangement offers the advantage that while contacting a body to be measured the membrane stretches over the surface thereof, thereby also allowing to measure bodies having curved surfaces.

According to one embodiment a removably arranged retaining body is provided that retains the membrane on the support body and the latter in a holder. This simple construction allows an uncomplicated replacement of the membrane.

According to a further embodiment multiple support bodies, retaining bodies, and membranes are received in the holder. In this manner, the device allows multiple particle transfers to be carried out consecutively before the analysis takes place.

Ultimately, according to a further embodiment, the device has a guide member comprising a base and arranged thereon a fixture for a body, and the holder is movable in the guide member toward the fixture. In this manner, imprints are always taken under identical conditions.

Exemplary embodiments of the invention will be explained in more detail hereinafter with reference to the accompanying drawings showing

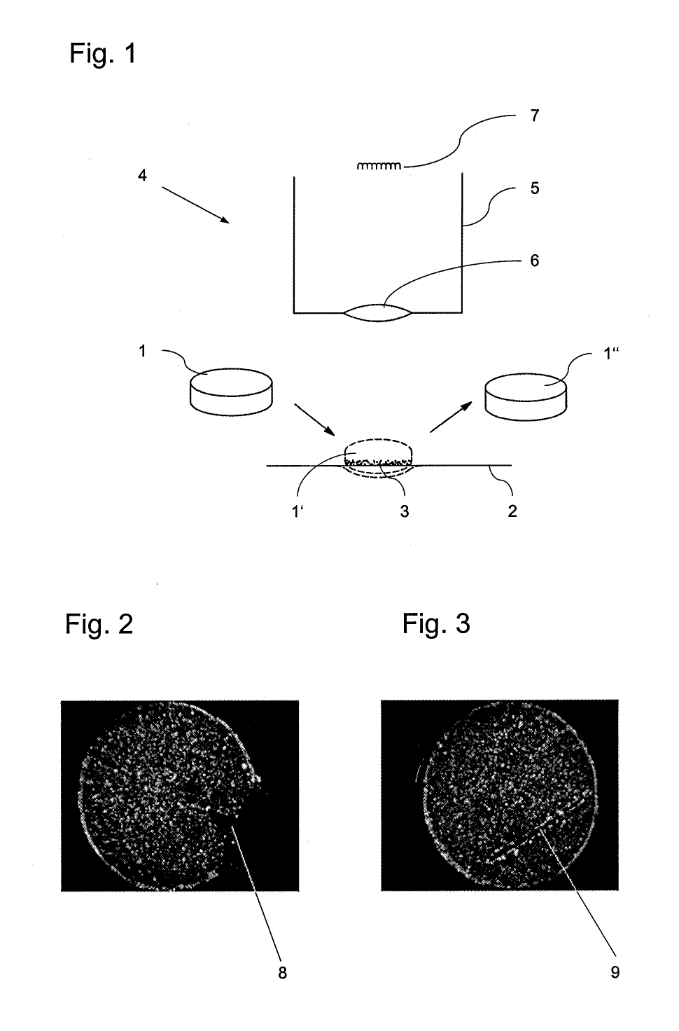

FIG. 1 a schematic illustration of an analyzing arrangement,

FIG. 2 a first illustration of an imprint,

FIG. 3 a second illustration of an imprint,

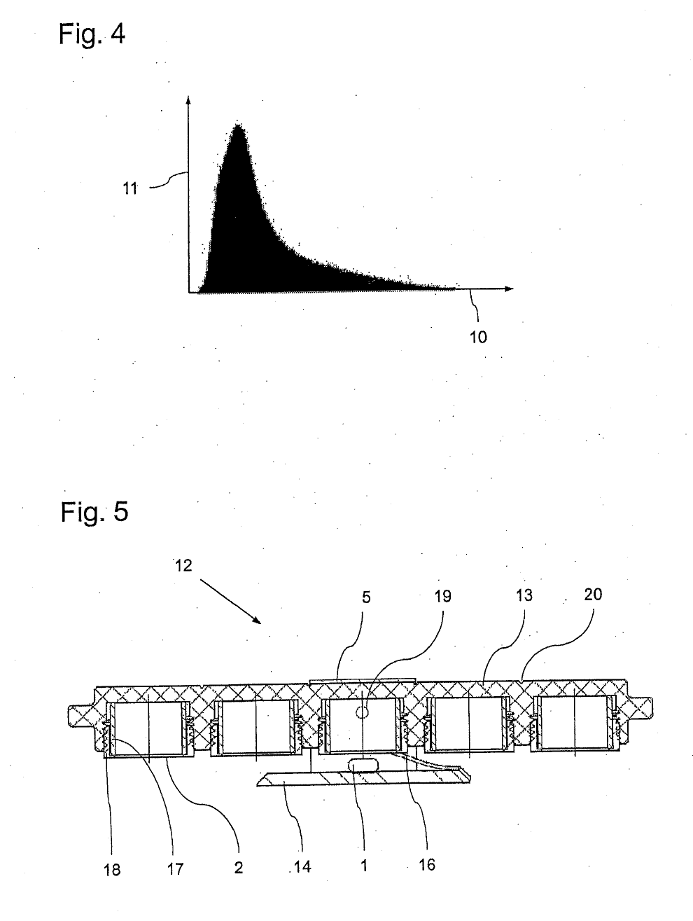

FIG. 4 a graph of the pixel count as a function of the gray value,

FIG. 5 a longitudinal section through a device for implementing the method of the invention, and

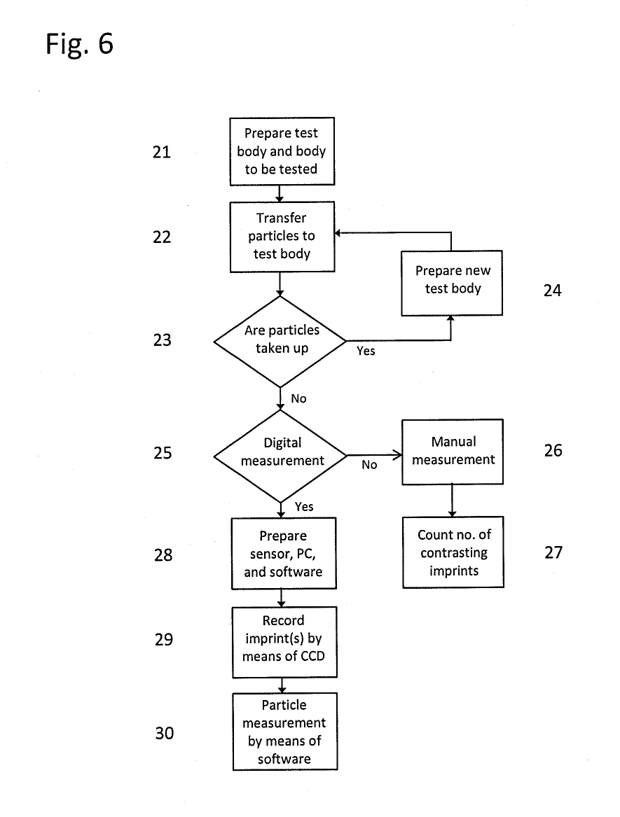

FIG. 6 a flow chart of the operations in an exemplary embodiment of the method of the invention.

FIG. 1 shows by way of example and schematically an arrangement for analyzing particles adhering to a body. The body is e.g. a pharmaceutical tablet 1. This tablet is brought into contact with an elastic membrane 2 while taking the position designated by 1′ in the Figure. As appears clearly in the Figure, membrane 2 is thereby elastically deformed and precisely adapts to the surface of tablet 1, even if this surface is curved. In tests, e.g. a thin rubber film as it is used for the manufacture of balloons has found to be suitable as a material for membrane 2. Advantageously, membrane 2 has a color that contrasts with the color of tablet 1. In the example, membrane 2 is black and tablet 1 is white. After bringing the tablet to the position designated by 1″, an imprint of particles 3 that have previously adhered to the surface of tablet 1 is left on membrane 2. The particles probably adhere to membrane 2 by mechanical adhesion. In order to improve the adhesion of particles 3 to membrane 2, membrane 2 may be coated with a pressure sensitive adhesive as it is e.g. used in adhesive tapes. According to one embodiment of the method of the invention, an image, preferably a digital image, of the area of membrane 2 comprising the imprint is taken. To this end, a camera 4 comprising a housing 5, a lens 6, and a photosensitive sensor 7, e.g. a CCD sensor, is schematically illustrated in FIG. 1.

FIGS. 2 and 3 each show a sector of the black membrane 2 with white particles adhering thereto. These particles can now be analyzed visually or automatically e.g. with regard to their number per surface area, their shape, size, distribution, size distribution, etc., e.g. in order to monitor the efficacy of a deduster through which the tablets 1 have previously passed. Furthermore, as shown in FIGS. 2 and 3, geometrical faults of tablet 1 such as a breakoff 8 (FIG. 2) or a scratch 9 (FIG. 3) can be recognized by the imprint.

FIG. 4 shows in a graph an example of the analysis of an image of the imprint of a tablet 1 recorded by camera 4. In the example, the gray value is plotted on horizontal axis 10 and the pixel count on vertical axis 11. Such an analysis can be performed automatically by a computer and a corresponding program. In the same manner, e.g. also the distribution of the particles on the measuring surface can be analyzed, thereby allowing to detect geometrical faults of tablets 1.

FIG. 5 shows a longitudinally sectioned view of a device 12 for implementing the method of the invention. Device 12 is intended for producing imprints manually and comprises a holder 13 that is dimensioned to fit into the human hand so that imprints are easy to take.

In the example, five cylindrical openings are provided in holder 13, in which respective sleeves 17 are received. A respective membrane 2 is stretched over each sleeve 17 and retained by means of a retaining ring 18 by which sleeve 17 is simultaneously fixed in the aforementioned opening. In order to improve the quality of the imprints and to allow a consistent positioning on membrane 2, device 12 has a base 14 with a recess for receiving a tablet 1. A kind of portal 15 serves for guiding holder 13, and positioning marks 20 indicate when a membrane 2 is centrally positioned above tablet 1. Advantageously, lateral guide pins 19 are provided in portal 15 which cooperate with corresponding guide grooves (not shown) in holder 13 and only allow a guided lowering movement of holder 13 toward tablet 1 when membrane 2 is positioned exactly over tablet 1. Starting from the position illustrated in FIG. 5, holder 13 is manually pressed down until membrane 2 contacts base 14, whereby membrane 2 stretches over tablet 1. After releasing holder 13, the latter is returned to the illustrated position by the force of a spring 16. Afterwards, holder 13 is displaced horizontally in the Figure until an adjacent membrane 2 is positioned over tablet 1.

Exemplary embodiments of the method of the invention will now be described with reference to the sequence of operations illustrated in the flow chart of FIG. 6. Position 21 stands for the preparation of the test body, i.e. in the preceding description membrane 2, and of the body to be tested, i.e. in the preceding description tablet 1. At 22, particles are transferred to the test body, e.g. by means of the device described with reference to FIG. 5. At 23 it is verified whether particles are visible on membrane 2. This verification may be performed visually by a person or automatically by an optical device such as a camera 4. If particles are recognizable on the test body, a new test body is prepared, as shown in position 24. When using the device according to FIG. 5, holder 13 is advanced by one position. At 25 it is decided whether the imprint is to be measured digitally, i.e. in this case electronically. A very simple embodiment of the method requires no electronic measurement, as shown in position 26, “manual measurement”. In this case, imprints of one and the same body are taken until no particles are recognizable on the test body any more. The number of imprints producing a contrast (27) can be taken as a simple measure of the particles adhering to the body before the first imprint and thus e.g. of the quality of a previously performed dedusting operation.

In the embodiment using the electronic measurement of the imprints, the sensor or the camera 4, respectively, a computer connected to camera 4, and a software installed on the computer are prepared at 28. To this end, camera 4 is e.g. equipped with a spacer sleeve that fits on retaining ring 18 so that the camera need not be refocused before each image. The spacer sleeve may be transparent so as to allow the passage of light into its interior, or it may be equipped with a light source in order to ensure identical lighting conditions for each image. At 29, the imprint is recorded by sensor 7 of camera 4, and at 30, the particle measurement by the aforementioned software is performed.

The method of the invention is e.g. applicable in the production of tablets, particularly for monitoring the efficacy of devices for tablet dedusting and deburring. Highly dust-free tablets are e.g. desired for optical reasons, particularly when the tablets are packaged in blister packages. However, a dust-free surface is also important in tablets that are to be coated with a layer as the layer might otherwise poorly adhere and/or have an unsightly appearance.

### LIST OF REFERENCE NUMERALS

1, 1′, 1″ tablet
2 membrane
3 particles
4 camera
5 housing
6 lens
7 sensor
8 breakoff
9 scratch
10 horizontal axis
11 vertical axis
12 device
13 holder
14 base
15 portal
16 spring
17 sleeve
18 retaining ring
19 guide pin
20 positioning marks
21 prepare test body and body to be tested
22 transfer particles to test body
23 are particles taken up?
24 prepare new test body
25 digital measurement
26 manual measurement
27 count number of imprints producing a contrast
28 prepare sensor, PC, and software
29 record imprint by means of CCD
30 particle measurement by means of software

1. Method for measuring particles adhering to a body, wherein particles are transferred from the body to a test body and are measured on the latter.

2. Method according to claim 1, wherein the test body has a color that differs from the color of the body.

3. Method according to claim 1, wherein the test body consists of a plastically or elastically deformable material.

4. Method according to claim 3, wherein the test body consists of synthetic material, rubber, or natural rubber.

5. Method according to claim 3, wherein the test body has the shape of a membrane.

6. Method according to claim 1, wherein the transfer of the particles to the test body is achieved by an electrostatic potential difference.

7. Method according to claim 1, wherein the transfer of the particles to the test body is achieved by a contact between the body and the test body.

8. Method according to claim 1, wherein the surface of the test body is coated with a pressure sensitive adhesive.

9. Method according to claim 1, wherein the measurement of the particles is achieved by analyzing a sector of the test body with the particles transferred thereto.

10. Method according to claim 9, wherein a digital image of the sector is recorded and electronically analyzed.

11. Method according to claim 9, wherein the analysis comprises determining the ratio of the sum of the projected areas of the particles relative to the total surface area of the sector.

12. Method according to claim 9, wherein the analysis includes determining the particle size distribution.

13. Method according to claim 8, wherein the analysis includes determining the particle distribution on the sector of the test body, and in that shape imperfections or damages of the body are deduced therefrom.

14. Method according to claim 1, wherein the transfer of the particles on one and the same body is repeated with respective new test bodies until no particles are detected on the test body any more, and the number of transfers where particles are detected on the test body is used as a measurement of the dust exposure of the body.

15. Method according to claim 1, wherein the body is a pressed body, in particular a pharmaceutical tablet or a capsule.

16. Device for implementing the method according to claim 1, comprising at least one test body, wherein the test body is in the form of an elastic membrane that is stretched over a hollow support body.

17. Device according to claim 16, further comprising a removably arranged retaining body that retains the membrane on the support body and the latter in a holder.

18. Device according to claim 16, wherein multiple support bodies, retaining bodies, and membranes are received in the holder.

19. Device according to claim 16, further comprising a guide comprising a base and arranged thereon a fixture for a body, and in that the holder is movable in the guide toward the fixture.

20. Method according to claim 2, wherein the color of the body is a contrasting color.
